(19) United States
(12) Patent Application Publication
(10) Pub. No.: US 2014/0085231 A1
(43) Pub. Date: Mar. 27, 2014

(54) INFORMATION PROCESSING APPARATUS AND DISPLAY CONTROL METHOD

(71) Applicant: Kabushiki Kaisha Toshiba, Tokyo (JP)

(72) Inventor: Takuya Ootani, Ome-shi (JP)

(21) Appl. No.: 13/910,749

(22) Filed: Jun. 5, 2013

(30) Foreign Application Priority Data
Sep. 26, 2012 (JP) 2012-213065

(51) Int. Cl. G06F 3/041

(52) U.S. Cl. CPC G06F 3/041
USPC 345/173

(57) ABSTRACT

According to one embodiment, an information processing apparatus includes: a calculator configured to calculate a screen operation position on a screen irregularly in accordance with a touch operation position on a touch device; a second calculator configured to calculate a predicted screen operation position on the screen based on the screen operation position at a calculation interval shorter than an update interval at which a display content on the screen is updated; and a generator configured to generate image data to be displayed on the screen based on the predicted screen operation position.

### CROSS-REFERENCE TO RELATED APPLICATIONS

This application is based upon and claims the benefit of priority from Japanese Patent Application No. 2012-213065, filed Sep. 26, 2012, the entire contents of which are incorporated herein by reference.

### FIELD

Embodiments described herein relate generally to an information processing apparatus and a display control method.

### BACKGROUND

Conventionally, an apparatus comprising a touch device such as a touch panel display and a pen tablet calculates screen operation positions on a screen based on detected touch operation positions and updates the screen based on a difference between the calculated screen operation positions if the touch operation positions on the touch device have been detected. The update of the screen includes scroll of the screen and movement of an item that is being dragged.

However, in the conventional technique, when a calculation cycle of the screen operation position is not constant or when noise is present at the calculated screen operation position, there are problems that a change in the difference between the calculated screen operation positions is increased and the screen is not updated smoothly in accordance with the calculated screen operation positions.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating the appearance of a personal digital assistant (PDA) as an information processing apparatus according to an embodiment;

FIG. 2 is an exemplary block diagram illustrating a main configuration of the PDA as the information processing apparatus in the embodiment;

FIG. 3 is an exemplary block diagram illustrating a functional configuration of the PDA as the information processing apparatus in the embodiment;

FIG. 4 is an exemplary flowchart illustrating flow of processing of calculating a screen operation position by a touch information processor of the PDA in the embodiment;

FIG. 5 is an exemplary flowchart illustrating flow of processing of calculating a predicted screen operation position by a touch information analyzer of the PDA in the embodiment;

FIG. 6 is an exemplary flowchart illustrating flow of processing of generating image data by a drawing controller of the PDA in the embodiment;

FIG. 7 is an exemplary timing chart illustrating timings at which the predicted screen operation position is calculated in the PDA in the embodiment; and

FIG. 8 is an exemplary graph for explaining the processing of calculating the predicted screen operation position in the PDA in the embodiment.

### DETAILED DESCRIPTION

In general, according to one embodiment, an information processing apparatus includes: a calculator configured to calculate a screen operation position on a screen irregularly in accordance with a touch operation position on a touch device; a second calculator configured to calculate a predicted screen operation position on the screen based on the screen operation position at a calculation interval shorter than an update interval at which a display content on the screen is updated; and a generator configured to generate image data to be displayed on the screen based on the predicted screen operation position.

Hereinafter, an information processing apparatus and a display control method according to an embodiment are described with reference to the accompanying drawings.

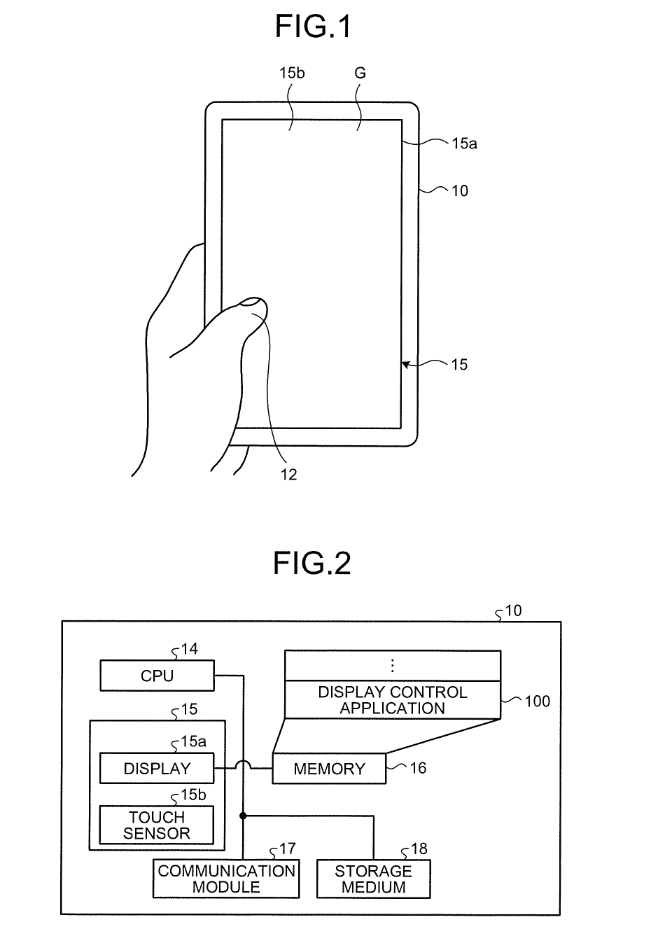

FIG. 1 is a view illustrating the appearance of a PDA as the information processing apparatus according to the embodiment. In the embodiment, the information processing apparatus is embodied as a personal digital assistant (PDA) 10 comprising a touch panel display. The touch panel display incorporates a display 15a as a display module comprising a screen G on which image data is displayed and a touch sensor 15b (touch device) stacked and arranged on the screen G.

As illustrated in FIG. 1, the PDA 10 comprises a touch panel display 15 incorporating the touch sensor 15b. The touch panel display 15 can select a display content on the screen G of the display 15a and update image data displayed on the screen G by a touch operation on the screen G with a finger 12, a touch pen, or the like.

FIG. 2 is a block diagram illustrating a main configuration of the PDA as the information processing apparatus in the embodiment. As illustrated in FIG. 2, the PDA 10 comprises a central processing unit (CPU) 14, the touch panel display 15, a memory 16, a communication module 17, and a storage medium 18.

The CPU 14 is a control device that controls various types of devices in the PDA 10 comprehensively. The CPU 14 loads an operating system (OS) and various types of applications such as a display control application 100 that are stored in the storage medium 18 onto the memory 16 to perform control.

The memory 16 is a storage medium such as a read only memory (ROM), a random access memory (RAM), and a flush memory in which data is stored.

The touch panel display 15 is a display device incorporating the display 15a and the touch sensor 15b. The display 15a comprises the screen G on which image data as a display target is displayed. The touch sensor 15b (touch device) detects a touch operation with the finger 12 of a user, the touch pen, or the like.

The storage medium 18 is a storage medium that stores the OS, various types of applications, and the like, and has a capacity larger than that of the memory 16 such as the flush memory. For example, the storage medium 18 is a hard disk drive (HDD).

The communication module 17 is a connection interface for connecting the PDA 10 to the Internet or the like.

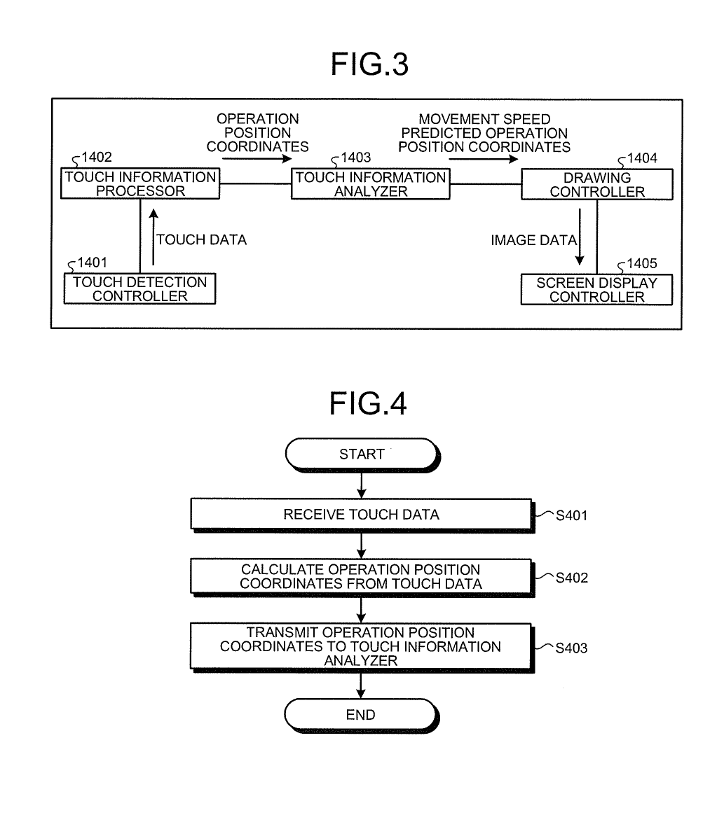

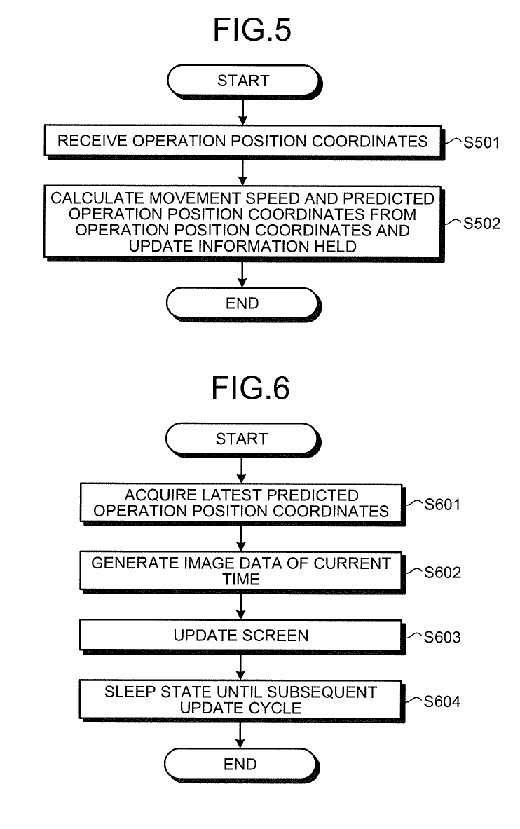

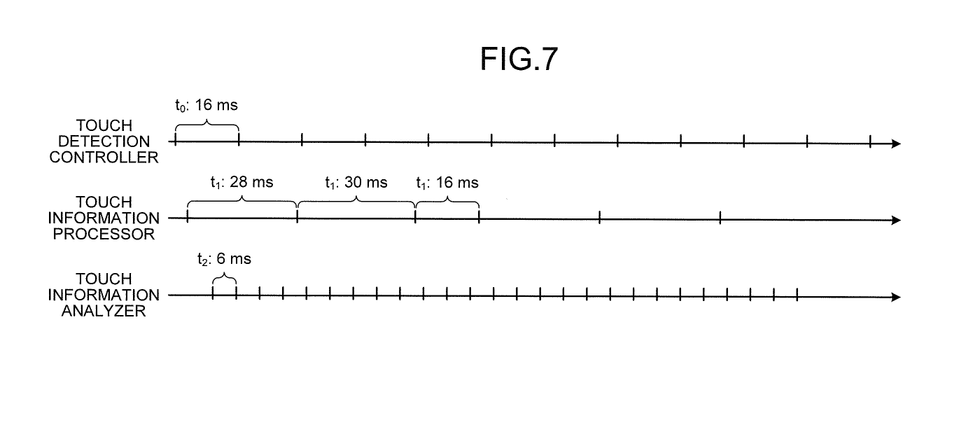

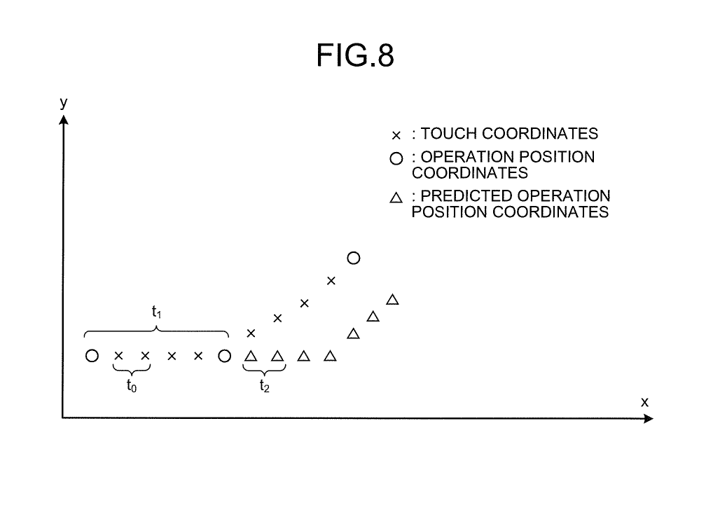

Next, description is given to processing of updating a display content on the screen G in the PDA 10 according to the embodiment with reference to FIGS. 3 to 8. FIG. 3 is a block diagram illustrating a functional configuration of the PDA as the information processing apparatus in the embodiment. FIG. 4 is a flowchart illustrating the flow of processing of calculating a screen operation position by a touch information processor of the PDA in the embodiment. FIG. 5 is a flowchart illustrating the flow of processing of calculating a predicted screen operation position by a touch information analyzer of the PDA in the embodiment. FIG. 6 is a flowchart illustrating the flow of processing of generating image data by a drawing controller of the PDA in the embodiment. FIG. 7 is a timing chart illustrating timings at which the predicted screen operation position is calculated in the PDA in the embodiment. FIG. 8 is a graph for explaining processing of calculating the predicted screen operation position in the PDA in the embodiment.

In the PDA 10 in the embodiment, the CPU 14 executes the display control application 100 stored in the storage medium 18 so as to operate a touch detection controller 1401, a touch information processor 1402, a touch information analyzer 1403, a drawing controller 1404, and a screen display controller 1405.

The touch detection controller 1401 detects a touch operation position at which a user performs a touch operation on the touch sensor 15b with the finger 12 thereof, the touch pen, or the like. In the embodiment, as illustrated in FIG. 7, the touch detection controller 1401 detects the touch operation position on the touch sensor 15b in a predetermined detection cycle t0 (for example, 16 ms). Then, the touch detection controller 1401 transmits touch data containing coordinates (hereinafter, referred to as touch coordinates) of the detected touch operation position to the touch information processor 1402 every time it detects the touch operation position.

The touch information processor 1402 functions as a calculator that calculates a screen operation position on the screen G irregularly based on the touch operation position detected by the touch detection controller 1401. In the embodiment, as illustrated in FIG. 4, the touch information processor 1402 receives the touch data from the touch detection controller 1401 every time the touch detection controller 1401 detects the touch operation position (S401). Then, the touch information processor 1402 calculates coordinates (hereinafter, referred to as operation position coordinates) of the screen operation position on the screen G based on the touch coordinates contained in the received touch data, as illustrated in FIG. 8 (S402). In this case, if processing having higher priority than the calculation of the operation position coordinates, such as generation processing of image data by the drawing controller 1404, which will be described later, and input processing of various pieces of information by a user of the PDA 10, is generated, the touch information processor 1402 changes an interval (hereinafter, referred to as coordinate calculation interval) at which it calculates the operation position coordinates based on the touch coordinates contained in the received touch data. For example, if the processing having higher priority than the calculation of the operation position coordinates, such as the generation processing of image data and the input processing of various pieces of information, is directed to be executed, even when the touch detection controller 1401 has detected the touch operation position in the detection cycle of t0: 16 ms, the touch information processor 1402 does not calculate the operation position coordinates in the same cycle as the detection cycle t0 of the touch detection controller 1401 but waits until the processing having higher priority than the calculation of the operation position coordinates is finished, as illustrated in FIG. 7. Thereafter, if the processing having higher priority than the calculation of the operation position coordinates, such as the generation processing of image data and the input processing of various pieces of information, has been finished, the touch information processor 1402 calculates the operation position coordinates after the coordinate calculation interval of t2: 28 ms, as illustrated in FIG. 7. Then, while the processing having higher priority than the calculation of the operation position coordinates is not executed, the touch information processor 1402 can calculate the operation position coordinates at a coordinate calculation interval t1 (for example, 16 ms) that is the same interval as the detection cycle t0. These indicate that the touch information processor 1402 calculates the operation position coordinates irregularly. Then, the touch information processor 1402 transmits the calculated operation position coordinates to the touch information analyzer 1403 (S403).

In the embodiment, the touch sensor 15b is stacked and arranged on the screen G, so that the touch information processor 1402 sets the touch operation position detected by the touch detection controller 1401 as the screen operation position on the screen G as it is. That is to say, when the touch operation position detected by the touch detection controller 1401 is a touch operation position on a touch pad provided as a separate body from the screen G, for example, the touch information processor 1402 converts the detected touch operation position into a screen operation position on the screen G in accordance with the size of the screen G.

As illustrated in FIG. 7, the touch information analyzer 1403 functions as a second calculator that calculates a predicted screen operation position on the screen G based on the screen operation position calculated by the touch information processor 1402. In this case, the touch information analyzer 1403 calculates the predicted screen operation position at an interval (hereinafter, referred to as calculation interval t2) shorter than an update interval (that is to say, interval at which a vertical synchronization signal is output) at which the display content on the screen G is updated. Note that the calculation interval t2 is the interval shorter than the update interval at which the display content on the screen G is updated as described above. To be more specific, the calculation interval t2 is substantially half or equal to or shorter than half the update interval at which the display content on the screen G is updated. This enables the touch information analyzer 1403 to calculate the predicted screen operation position at the timing close to the timing at which the display content on the screen G is updated.

In the embodiment, the touch information analyzer 1403 receives calculated operation position coordinates every time the touch information processor 1402 calculates the operation position coordinates (S501). Then, the touch information analyzer 1403 calculates a movement speed of the operation position coordinates on the screen G based on a plurality of received operation position coordinates at the calculation interval t2 and calculates predicted operation position coordinates when the operation position coordinates are moved at the calculated movement speed (S502). In this case, as illustrated in FIG. 7, the touch information analyzer 1403 keeps calculating the predicted operation position coordinates based on the operation position coordinates received in the past at the calculation interval t2 regardless of whether the touch information analyzer 1403 has received the operation position coordinates from the touch information processor 1402 since it has calculated the predicted operation position coordinates last. As the coordinate calculation interval t1 at which the touch information processor 1402 calculates the operation position coordinates is longer, the predicted operation position coordinates to be calculated by the touch information analyzer 1403 are deviated from actual operation position coordinates in some cases, as illustrated in FIG. 8. To address this, the predicted operation position coordinates are calculated at the calculation interval t2 regardless of the coordinate calculation interval t1. This makes it possible to prevent a change in the difference between the predicted operation position coordinates to be used for generating image data from increasing. In addition, the touch information analyzer 1403 updates pieces of information (movement speed and predicted operation position coordinates) that have been calculated in the past and held with the calculated movement speed and the predicted operation position coordinates (S502).

To be more specific, the touch information analyzer 1403 stores several tens to several hundreds of latest calculated operation position coordinates. Then, the touch information analyzer 1403 calculates the movement seed of the operation position coordinates by using at least two latest calculated operation position coordinates and the coordinate calculation interval t1 at which the two operation position coordinates have been calculated. It is to be noted that the touch information analyzer 1403 may calculate the movement speed by least-squares polynomial approximation or the like using the several tens to several hundreds of latest calculated operation position coordinates. Next, the touch information analyzer 1403 calculates the predicted operation position coordinates when the operation position coordinates on the screen G are moved at the calculated movement speed and at the calculation interval t2. In this manner, the touch information analyzer 1403 calculates the movement speed of the screen operation positions based on the calculated screen operation positions and calculates the predicted screen operation positions when the screen operation position is moved at the calculated movement speed.

Furthermore, the touch information analyzer 1403 corrects the movement speed of the screen operation position in accordance with the difference between the screen operation position calculated by the touch information processor 1402 and the calculated predicted screen operation position. In the embodiment, the touch information analyzer 1403 corrects the movement speed such that the difference between the screen operation position calculated by the touch information processor 1402 and the calculated predicted screen operation position is decreased in a stepwise manner every time the drawing controller 1404, which will be described later, generates image data. This makes it possible to prevent elimination of the difference between the screen operation position and the predicted screen operation position at the timing when the drawing controller 1404, which will be described later, generates image data once.

To be more specific, when a movement distance of the predicted operation position coordinates is smaller than a movement distance of the operation position coordinates calculated by the touch information processor 1402, the touch information analyzer 1403 increases the movement speed of the screen operation position by a predetermined rate (for example, 3 pix/sec) until the movement distance of the operation position coordinates and the movement distance of the predicted operation position coordinates become substantially identical. On the other hand, when the movement distance of the calculated predicted operation position coordinates is larger than the movement distance of the operation position coordinates calculated by the touch information processor 1402, the touch information analyzer 1403 decreases the movement speed of the screen operation position by a predetermined rate (for example, 3 pix/sec) until the movement distance of the operation position coordinates and the movement distance of the predicted operation position coordinates become substantially identical. It is sufficient that the predetermined rate is set to the degree that the difference between the screen operation position and the predicted screen operation position is not eliminated at the timing when the image data is generated once. This makes it possible to prevent elimination of the difference between the screen operation position coordinates calculated by the touch information processor 1402 and the predicted screen operation position coordinates calculated by the touch information analyzer 1403 at the timing when the drawing controller 1404, which will be described later, generates image data once. The display content on the screen G can therefore be updated more smoothly.

The drawing controller 1404 functions as a generator that generates image data to be displayed on the screen G based on the predicted screen operation position calculated by the touch information analyzer 1403. In this case, the drawing controller 1404 generates the image data as the display target by using the predicted screen operation position regardless of whether the predicted screen operation position calculated by the touch information analyzer 1403 reaches the screen operation position calculated by the touch information processor 1402.

In the embodiment, the drawing controller 1404 acquires latest predicted operation position coordinates calculated by the touch information analyzer 1403 in a predetermined generation cycle (S601). Then, the drawing controller 1404 generates image data of the current time in accordance with the acquired predicted operation position coordinates (S602). For example, the drawing controller 1404 generates image data scrolled such that the acquired predicted operation position coordinates are positioned at the center of the screen G, generates image data obtained by moving a dragged item to the predicted operation position coordinates on the screen G, and generates image data by drawing a locus on which the calculated predicted operation position coordinates are moved.

Next, the screen display controller 1405 acquires the latest image data generated by the drawing controller 1404 in the update cycle in which the display content on the screen G is updated, and updates the display content on the screen G in accordance with the acquired image data (S603). Then, the screen display controller 1405 gets into a sleep state without updating the display content on the screen G till a subsequent update cycle (S604).

Thus, the PDA 10 according to the embodiment calculates a screen operation position on the screen G irregularly in accordance with a touch operation position on the touch sensor 15b, calculates a predicted screen operation position on the screen G based on the calculated screen operation position at the calculation interval shorter than the update interval at which the display content on the screen G is updated, and generate image data based on the predicted screen operation position. This makes it possible to prevent a change in the difference between the calculated predicted screen operation positions from being increased. The display content on the screen G can therefore be updated more smoothly in accordance with the predicted screen operation positions.

In the embodiment, the PDA 10 in which the touch sensor 15b is integrally formed has been described. The embodiment can be also applied to an information processing apparatus (for example, display) that receives a screen operation position from a touch device that is not integrally formed with the information processing apparatus (in other words, is configured as a separated body from the information processing apparatus), such as a touch pad and a pen tablet, and generates image data to be displayed on the screen G based on the received screen operation position. In this case, the touch device such as the touch pad and the pen tablet comprises the touch detection controller 1401 that detects a touch operation position on the touch device and the touch information processor 1402 that calculates a screen operation position on the screen G irregularly in accordance with the touch operation position on the touch device. Meanwhile, the information processing apparatus comprises the touch information analyzer 1403 that calculates a predicted screen operation position on the screen G based on the screen operation position calculated by the touch information processor 1402 at the calculation interval shorter than the update interval at which the display content on the screen G is updated and the drawing controller 1404 that generates image data to be displayed on the screen G based on the predicted screen operation position calculated by the touch information analyzer 1403.

Programs to be executed in the PDA 10 in the embodiment are provided by being incorporated in a read-only memory (ROM) or the like previously.

Furthermore, the programs to be executed in the PDA 10 in the embodiment may be configured to be provided by being recorded in a recording medium that can be read by a computer, such as a compact disc read only memory (CD-ROM), a flexible disk (FD), a CD recordable (CD-R), or a digital versatile disk (DVD), in an installable or executable file format.

Furthermore, the programs to be executed in the PDA 10 in the embodiment may be configured to be provided by being stored on a computer connected to network such as the Internet and being downloaded through the network. Alternatively, the programs to be executed in the PDA 10 in the embodiment may be configured to be provided or distributed through network such as the Internet.

The programs to be executed in the PDA 10 in the embodiment have a module configuration comprising the above-mentioned parts (touch detection controller 1401, touch information processor 1402, touch information analyzer 1403, drawing controller 1404, and screen display controller 1405). As actual hardware, a CPU (processor) loads the programs from the above-mentioned ROM and executes the programs, so that the above-mentioned parts are loaded on a main storage device. With this, the touch detection controller 1401, the touch information processor 1402, the touch information analyzer 1403, the drawing controller 1404, and the screen display controller 1405 are generated on the main storage device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a calculator configured to calculate a screen operation position on a screen irregularly in accordance with a touch operation position on a touch device;
a second calculator configured to calculate a predicted screen operation position on the screen based on the screen operation position at a calculation interval shorter than an update interval at which a display content on the screen is updated; and
a generator configured to generate image data to be displayed on the screen based on the predicted screen operation position.

2. The information processing apparatus of claim 1, wherein the calculation interval is substantially half the update interval.

3. The information processing apparatus of claim 1, wherein the second calculator is configured to calculate a movement speed of the screen operation position based on the screen operation position, calculate the predicted screen operation position when the screen operation position is moved at the movement speed, and correct the movement speed in accordance with a difference between the screen operation position and the predicted screen operation position.

4. The information processing apparatus of claim 3, wherein the second calculator is configured to correct the movement speed such that the difference between the screen operation position and the predicted operation position is decreased in a stepwise manner every time the image data is generated.

5. A display control method performed with an information processing apparatus, the display control method comprising:
calculating, by a calculator in the information processing apparatus, a screen operation position on a screen irregularly in accordance with a touch operation position on a touch device;
second calculating, by a second calculator in the information processing apparatus, a predicted screen operation position on the screen based on the screen operation position at a calculation interval shorter than an update interval at which a display content on the screen is updated; and
generating, by a generator in the information processing apparatus, image data to be displayed on the screen based on the predicted screen operation position.
